(19) United States
(12) Patent Application Publication
(10) Pub. No.: US 2006/0005439 A1
(43) Pub. Date: Jan. 12, 2006

(54) Souvenir display frame

(75) Inventors: Terumi Matsumura, Torrance, CA (US); Hideyo Shimaki, Irvine, CA (US); Yuka Oshimi, Gardena, CA (US); Kel Shimojo, West Hollywood, CA (US)

Correspondence Address: HOGAN & HARTSON L.L.P., 500 S. GRAND AVENUE, SUITE 1900, LOS ANGELES, CA, 90071-2611, US

(73) Assignee: TOBUTSU AMERICA CORPORATION

(21) Appl. No.: 10/887,280

(22) Filed: Jul. 7, 2004

(51) Int. Cl. G09F 3/00; A47G 1/06

(52) U.S. Cl. 40/310; 40/800

(57) ABSTRACT

A souvenir display frame is configured to display souvenirs or keepsakes related to a bottle of wine. The display frame includes areas configured to display flat souvenir items such as photographs, labels, and in particular, a wine label that has been lifted from a wine bottle and preserved as a keepsake. The preferred embodiment also includes a display area for displaying a solid object, and in particular the wine bottle's cork. The frames can be sold directly to consumers who want to display keepsakes related to their consumption of wine, or the frames can be sold to commercial establishments at which bottled wine is sold and drunk. The commercial establishment can then provide its patrons with souvenir frames along with preserved labels, corks, and other souvenir keepsakes associated with the patron's purchases.

### BACKGROUND OF THE INVENTION

Many people enjoy drinking wine and other such special beverages. Wine and other beverages are often drunk, for example, at dinners, weddings, and other special occasions that people would like to commemorate and remember. Some people will save the bottle from a wine that was drunk at such an occasion; others will keep just the cork. Picture frame-like frames and similar devices exist for displaying wine corks as keepsakes.

Other devices allow one to lift the label from a wine bottle or another beverage container and then to preserve the label as a keepsake. Such a device is shown in FIG. 1, which illustrates a wine label 1 being lifted off of a wine bottle 2, by means of an thin transparent film adhesive tape 3. A user of the tape presses the tape firmly over the wine bottle label. An adhesive on the tape grips the label, so that the label is lifted when the tape is peeled away from bottle. The tape can then be applied to a card or another such object so that the front of the label is visible through the transparency of the tape. The card with the label on it then serves as a souvenir or memento of the wine or the occasion at which it was consumed. FIG. 1 also shows the wine bottle's cork 4, which has been removed from the bottle, and which the wine drinker might want to save as an additional keepsake.

### SUMMARY OF THE INVENTION

A preferred embodiment of the invention provides a souvenir display frame configured to display souvenirs or keepsakes related to a bottle of wine. The display frame includes areas configured to display flat souvenir items such as photographs, labels, and in particular, a wine label that has been lifted from a wine bottle and preserved as a keepsake. The preferred embodiment also includes a display area for displaying a solid object, and in particular the wine bottle's cork.

Embodiments of the invention can be sold directly to consumers who want to display keepsakes related to their consumption of wine. In the alternative, the embodiments of the invention can be sold to commercial establishments at which bottled wine is sold and drunk. The commercial establishment can then provide its patron with a souvenir display device along with a preserved label, a wine bottle cork, or other souvenir keepsakes associated with the patron's purchase.

### BRIEF DESCRIPTION OF THE DRAWINGS

FIG. 1 illustrates known means for using an adhesive film or tape to lift and remove a wine bottle label from the bottle that carries the label.

FIG. 2 is a perspective view illustrating a souvenir display frame that embodies the invention.

FIG. 3 is a bottom view of the display frame shown in FIG. 2.

FIG. 4 is a view of the constituent parts that make up the assembly shown in FIGS. 2 and 3.

FIG. 5 depicts constituent elements of a display subassembly according to an alternative preferred embodiment.

FIG. 6 shows a foldable insert element for use in the display area of FIG. 5 in an unfolded configuration.

FIG. 7 shows the elements of FIG. 5 assembled together to complete the display subassembly.

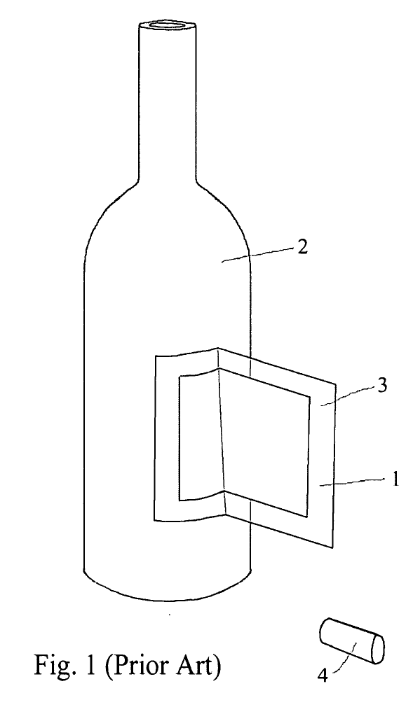

### DESCRIPTION OF THE PREFERRED EMBODIMENTS

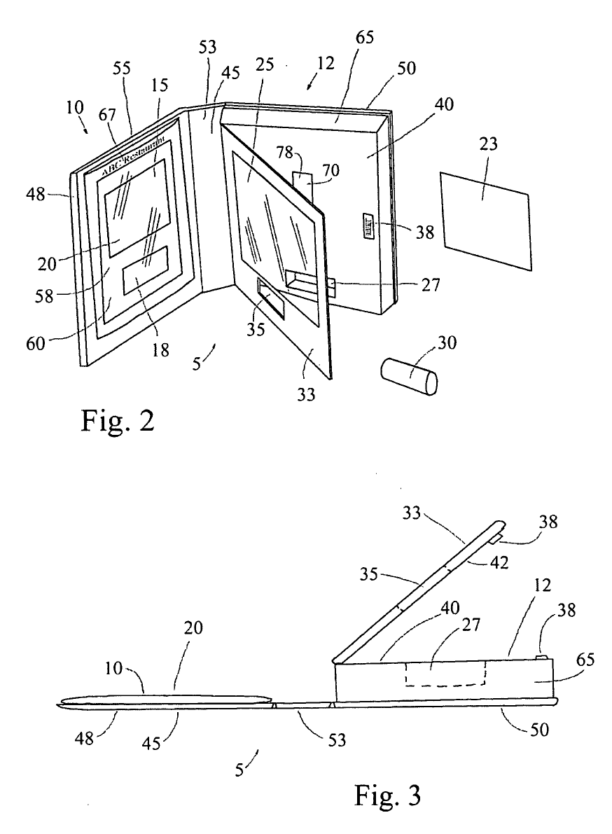

FIG. 2 is a perspective view of a souvenir display frame 5 that embodies the invention. The frame is constructed in a hinged, folding book-like configuration with a first, left-side display area 10 and a second, right-side display area 12. The left-side display area 10 is sized and configured to receive and display a first flat souvenir item 15 and a second flat souvenir item 18 behind a first transparent protective window material 20.

The right-side display area 12 is sized and configured to display a third flat souvenir item 23 behind a second transparent protective window material 25. The right-side display area also features a space 27 configured to receive, hold, and display a solid souvenir object 30, just below the second transparent protective window material 25. The preferred embodiments described in this document are contemplated for the display of wine bottle corks or similar beverage container stoppers as the solid souvenir object to be received in the space, but similar schemes may be devised and applied for the display of other solid souvenirs or keepsakes.

The right-side display area 12 is positioned behind a folding leaf 33, which is hinged to one side of the right-side display area. The leaf 33 carries the transparent second window material 25. When the leaf is closed, the third flat souvenir item 23 will be visible (when the frame is open) through the second window material 25. The solid souvenir 30 held in the space 27 will be visible through another window 35 in the leaf. In a preferred embodiment, the window 35 may be a simple opening or cut-out formed through the material of the leaf 33.

A closure material 38 on the right-side display area 12 holds the leaf 33 closed over the right-side display area while allowing a user of the frame 5 to open or close the leaf, e.g., to place a third flat souvenir item 23 on the right-side display area or to place a solid souvenir object 30 into the space 27 configured to receive it. The closure material may be, for example, a hook-and-loop fabric material such as VELCRO®, a small magnet, a snap closure, or the like, positioned as appropriate on one or both of a facing surface 40 of the right-side display area and an under surface 42 of the leaf 33.

FIG. 3 is a bottom view of the souvenir display frame 5, illustrating in particular the space 27 configured to receive the solid object and the leaf 33 hinged at one side of the right-side display area 12.

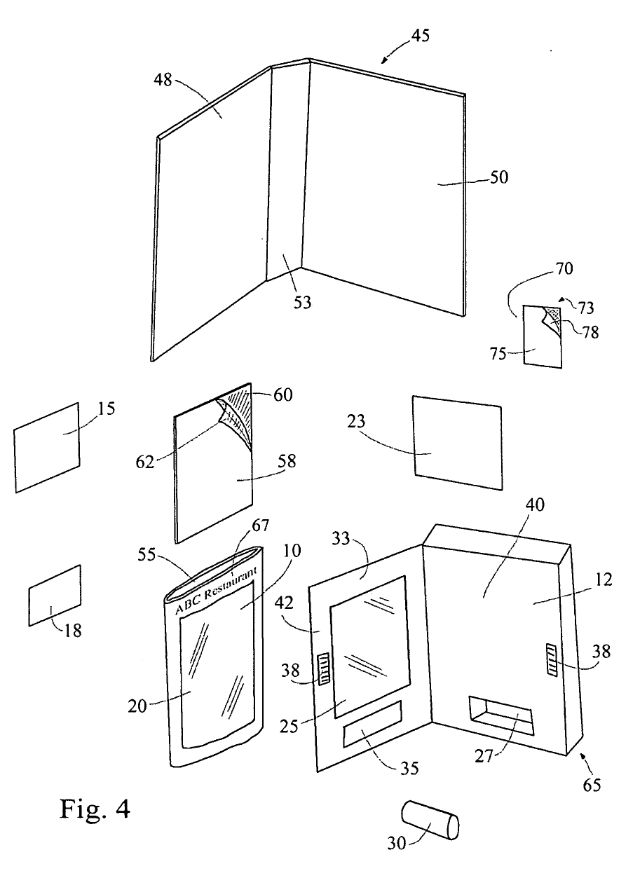

FIG. 4 illustrates the constituent parts that comprise the souvenir display frame assembly depicted in FIGS. 2 and 3. The assembly is held inside a folding outside cover material 45. The cover material serves in much the same way and can be made of similar materials as the outer cover of a hardback book. The cover material can be for example, a card stock material covered by a fabric material, or any other suitable material printed or otherwise provided with attractive and adequately durable outer surfaces.

The cover material 45 includes a left-hand cover side 48 and a right-hand cover side 50 with a central cover spine 53 located between and hinged on either side of the spine to each of the cover sides 48 and 50.

The left-side display area 10 is in the form of a slim pouch, with an opening 55 at the top of the pouch. A display card 58 is insertable into the pouch through the opening. The display card in a preferred embodiment is similar to a single page of a conventional photo album. A front-facing display face of the card carries a dry, non-slip material intended to hold the first and second flat souvenir items 15 and 18 in place and keep them from sliding down across the face of the card. The display face 58 is ordinarily covered by a transparent film sheet 62, which can be peeled away from the card's display face to place the souvenir items on the card, but which is then laid back down on the card to hold the souvenirs in place. The display card 58 slips back into the left-side display area 10 through the opening 55 at the top of the display area pouch.

The left side display area pouch 10 is fixed with an adhesive or any other suitable means to the left-hand cover side 48 of the cover material 45. (See. FIGS. 2 and 3.)

The right side display area 12 includes a box structure 65. The leaf 33 is hinged at one side to this box structure. An opening in the front face of the box structure opens into the space 27 that is configured to receive the solid souvenir object 30. The box structure can be formed of any suitable material, including card stock covered with various combinations of cork sheeting, decorative papers or films, fabrics, or attractive surface coverings. The box structure is fixed to the right-hand cover side 50 of the cover material 45. The left- and right-side display structures and the left- and right-side covers and the central spine of the cover material are sized and configured so that the frame can be opened to display the souvenirs, as illustrated in FIG. 2, or closed like a book at other times when the souvenirs are not being displayed in the frame.

The souvenir display frame 5 described above may be used to display keepsakes associated with a high-quality wine, a wine that was drunk at a particularly significant occasion, or any wine that the owner of the frame would like to remember and for which the owner would like to display souvenirs. In a preferred embodiment, the first flat souvenir item 15 is a photograph, perhaps of a festive group of diners or drinkers who were at the table when the wine was opened and drunk. The second flat souvenir item 18 can be a label, which can be supplied with the souvenir frame and which may bear blank spaces onto which the owner of the frame can write details of the wine in question—its name, vintage, the date on which it was opened, tasting impressions, the names of those present, or the like.

The label 18 and the space for displaying it may conveniently be about the size of an ordinary business card. Where this is the case, a user of the device may display either the label with desired information written on it, or a business card taken from a restaurant at which the wine was served, a person who gave the wine as a gift, or some other entity related to the wine or the event at which the wine was drunk.

The third flat souvenir item 23 can be the wine label itself, lifted with an adhesive film or otherwise removed from the wine bottle and preserved as a keepsake.

The frame 5 will generally be sold to a consumer as an assembly that includes a blank form or label as the second flat souvenir item 18 shown in FIG. 2. After opening and drinking a bottle of wine, the owner can place a photograph commemorating the occasion in the space provided for the first flat souvenir item 15, and write whatever information he would like to see on the spaces provided on the label 18. After removing the wine label from the bottle, the user can place the preserved label in the space provided for the third flat souvenir item 23, and put the wine cork 30 into the space 27 provided for it. The user can then display the frame along with the keepsakes commemorating his drinking of the wine.

The assembly includes a double-sided adhesive tape 70. The tape includes adhesive on both sides. A relatively strong adhesive on a back side 73 of the tape adheres the tape more or less permanently to the facing surface 40 on the right-side display area 12.

A relatively weaker removable adhesive is supplied on a front side 75 of the tape 70. This relatively weaker adhesive can be, for example, the same general type of adhesive that the 3M™ Corporation uses on its Post-it® brand removable note papers. The weak adhesive on the front side of the tape lies under a protective film or paper 78. A user of this device can peel away this protective layer to expose the relatively weak adhesive so that the wine label 23 can be applied to the facing surface 40 and held there by the tape. Because the adhesive on the front of the tape is relatively weak, the wine label can be lifted from the tape and repositioned or replaced as the user prefers. The 3M™ Corporation sells a tape suitable for this purpose under its product name “3M™ Removable Repositionable Tape 9415 PC.”

The tape can be of any appropriate size. This embodiment includes a tape 20 millimeters wide and 30 millimeters high.

Wine corks generally come in a fairly wide range of lengths, but only in a very narrow range of diameters clustered around a single standard diameter corresponding to the internal diameter of a standard wine bottle neck. The space 27 that receives the cork and the window 35 through which the cork is displayed can thus be sized accordingly. In particular, the space 27 should be somewhat taller and deeper than the standard cork diameter, so that the cork will fit easily into the space. The space may be wider moreover, than the longest cork length of a range of differing cork lengths, so that any cork having a length within this range will fit within the space.

Some three hundred ordinary wine bottle corks were measured and found to have various lengths within a range from about 35 to 55 millimeters. The space 27 may thus preferably have a width of at least 55 millimeters, or in the alternative a width of at least 60 millimeters. The space will most preferably have a width within a range between 55 and 60 millimeters.

The corks were further found to have diameters falling within about 19 and 24 millimeters. The space 27 may thus have a height and a depth of at least about 24 millimeters, and in other cases a height and a depth of at least about 25 millimeters or more.

The window 35 should be sized to hold the cork inside the space 27. In particular, at least one of two conditions should be met: (1) the height of the window opening should be somewhat smaller than the standard cork diameter; or (2) the width of the window opening should be somewhat smaller than the shortest cork from within a variety of corks having lengths within a predetermined range.

In one embodiment, the window 35 has a width of about 55 or 56 millimeters. In that embodiment, the window has a height of no more than about 20 millimeters, and more preferably a height of no more than about 18 millimeters. The height of the window thus being somewhat less than the diameter of the smallest usual cork, the window will secure the cork inside the space while still allowing most of the cork to be visible through the window.

As noted above, the frame assembly 5 may commonly be sold directly to consumers who wish to display souvenirs of wine that they themselves have drunk. As an alternative, the frame assembly can be sold by a manufacturer or a distributor to a restaurant, a bar, or another commercial establishment which sells wine for consumption on the premises. After the patron drinks the wine, the restaurant can further serve the patron by offering to remove the label from the bottle for him, take a photograph and save the cork, and then provide the souvenir frame to the customer with the keepsakes placed inside it. This can provide the establishment with a source of additional revenue through the sale of keepsakes and an associated display device, give the patron an enduring reminder of an enjoyable occasion, and build loyalty on the part of the patron, who will be reminded of the establishment each time he looks at the souvenir display. As FIGS. 2 and 3 illustrate, the display device may bear information 67 signifying the identity of the restaurant or commercial establishment. The information can be printed onto or otherwise provided onto the display device above the first window material 20 (as shown in the drawings), below it, or at any suitable location.

A manufacturer or seller of such items may thus sell to a restaurant or a similar commercial establishment (1) a supply of adhesive tapes or similar supplies for lifting labels from wine bottles and preserving them as keepsakes; and (2) a souvenir frame, display stand, or another device adapted to display the preserved wine bottle label. The commercial establishment would then offer to remove the wine bottle label from the bottle and provide that label to the patron along with the display device. The display device can be in the form a display frame of the type described above, or it could be another type of display device different from the one described above but nevertheless adapted to display the preserved wine bottle label.

A restaurant or other commercial establishment may purchase devices for lifting and preserving labels removed from wine bottles along with display devices of the type described herein, or separately from the same or a different source as the one from which it acquires the display devices.

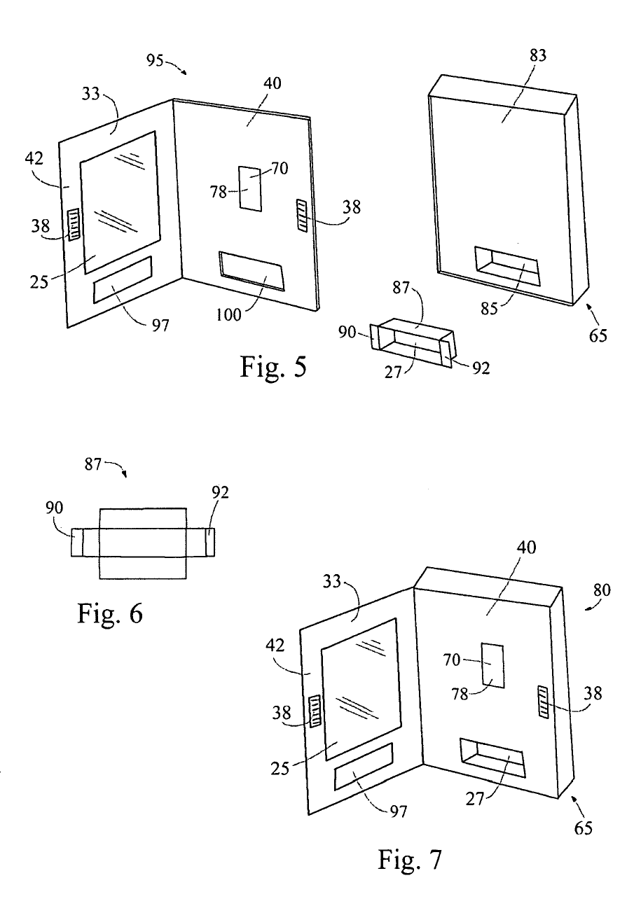

FIGS. 5, 6, and 7 illustrate elements of a right-side display area assembly 80 that is used in one preferred embodiment of a display device according to the invention.

Referring specifically to FIG. 5, the assembly includes a box structure 65, with a front-side receiving area 83, and an insert-receiving space 85. The assembly also includes a space-defining insert 87, which is generally rectangular in shape with an opening on one side so that a space 27 is defined inside the insert. The insert also includes a left-side tab 90 and a right-side tab 92 on either side of the opening that defines the space.

The final major element of the right-side display area assembly is a folding frontpiece 95. The frontpiece includes a facing surface 40 that will provide a location for the display of a wine bottle label or another flat keepsake. As in the prior embodiment, a piece of double-sided adhesive tape 70 is situated on the facing surface 40, and the tape is protected by a peel-away facing paper 78. Closure materials 38 are located on either side of the frontpiece's fold.

A first, outer window 97 is defined as a cut-out in the material on one side of the frontpiece 95, and a second, inner window 100 on the other. These windows are situated to align at least generally with one another when the frontpiece is closed along its fold. The front side leaf 33 of the frontpiece has a further, generally much larger window, which is provided with a window material 25, as in the prior embodiment.

The box-shaped insert 87 is folded from a pre-cut piece of card stock or another suitable material. The shape of the insert before folding is illustrated in FIG. 6, which shows the structures that will form the sides and back of the insert, along with the tabs 90 and 92 that will hold the folded insert in place.

In putting the assembly together, the space-defining insert 87 is placed into the insert-receiving space 85 of the front-side receiving area 83 on the box structure 65. A small amount of glue or tape on the left-side tab 90 and the right-side tab 92 can be used to hold the insert in place. With the insert in place, the frontpiece 95 is placed onto the box structure's front-side receiving area. In a preferred embodiment, the front-side receiving area is recessed somewhat below the side walls of the box, so that the frontpiece lies generally flush with the sides of the box. The frontpiece 95 hides the tabs 90 and 92 of the insert behind the structure that defines the inner window 100.

In the preferred embodiment described here, the outer window 97 in the leaf 33 of the frontpiece 95 is about 18 millimeters high and about 55 millimeters wide. The inner window 100 through the other side of the frontpiece is about 23.5 millimeters high and about 60 millimeters wide. The opening 27 at the front of the insert 87 is about 25.5 millimeters high and about 65.5 millimeters wide. Note that these dimensions increase from piece to piece as one moves backward from the front window to the insert. This contributes to the ease of assembly of the display, in that these three openings and spaces to not have to be aligned with complete precision with one another; some degree of manufacturing tolerance is provided thereby with respect to the alignment of these elements. The dimensions of the insert-receiving space 85 are not critical, so long as the space is big enough to fully receive the insert 87.

The completed assembly 80 appears generally as shown in FIG. 7. After completion, the assembly can then be included in a greater overall assembly that corresponds to the one that is shown, e.g., in FIG. 2 and described above as the prior embodiment.

The depth of the insert 87 is such that there is about 21.5 millimeters of total depth between the backside of the insert and the front-most surface on the front side of the leaf 33 on the frontpiece 95 when the entire assembly is completed. Note that this will be somewhat less than the diameter of many standard corks, which typically have diameters ranging from about 19 millimeters to 24 millimeters. This is permissible, though, as the middle portion of the cork can project slightly beyond the front surface of the outer window 97 while still being retained by the top and bottom edges of the window. This slight projection of the cork outside of the window is visually attractive, in fact, so long as the cork does not extend outward so far that it interferes with the book-style closing of the overall assembly.

Although the invention has been described above in connection with a preferred embodiment of a souvenir frame for displaying keepsakes kept in connection with the drinking of bottled wine, aspects of the invention may be equally applicable to keepsakes related to other beverages, or indeed to other items that a user might wish to display and which might or might not relate to beverages.

The foregoing preferred embodiment of the display frame has also been described as being suitable for use in a business method whereby a commercial establishment provides its customers with such display apparatus in connection with its sales to customers of bottled beverages. Although the novel display frame is certainly suitable for use in such a business method, the method is not so limited, and other display devices may find use in such methods as well.

It is likely, moreover, the further modifications, additions, and improvements may be devised by those of skill in the art, and the invention is not to be deemed limited to the preferred embodiments and modes described above. The scope of the invention should instead be determined primarily by reference to the following patent claims, along with the full scope of equivalents to which those claims are rightfully and legally entitled.

What is claimed is:

1. A display device comprising:
structure defining a space configured to receive and display a generally cylindrical beverage stopper; and
a window overlying the space, wherein the window includes structure defining an opening aligned with the space so that a beverage stopper inside the space can be viewed through the window;
wherein the window has at least one dimension smaller than a corresponding dimension of the beverage stopper so that the structure defining the window will confine the beverage stopper inside the space.

2. The display device of claim 1, wherein the beverage stopper is a standard-sized wine bottle cork, wherein a height of the window is smaller than an external diameter of the wine bottle cork.

3. The display device of claim 2, wherein the height of the window is no more than about 20 millimeters.

4. The display device of claim 3, wherein the height of the window is no more than about 18 millimeters.

5. The display device of claim 1, wherein the beverage stopper is a standard wine bottle cork, and wherein the space has a width greater than the length of the longest of a range of lengths common to standard wine bottle corks.

6. The display device of claim 5, wherein the space has a width of at least 55 millimeters.

7. The display device of claim 6, wherein the space has a width in the range from 55 to 60 millimeters.

8. The display device of claim 6, wherein the space has a width of at least 60 millimeters.

9. A display device comprising:
structure configured to receive and display a beverage stopper removed from a container previously containing a beverage; and
structure configured to receive and display a label removed from the beverage container in close association with the beverage stopper removed from the container;
wherein the structure configured to receive and display the label includes a generally planar surface upon which the label can be placed and supported;
and wherein the structure configured to receive and display the beverage stopper includes structure defining an opening in the generally planar surface into which the beverage stopper can be placed and held for display.

10. The display device of claim 9, wherein the beverage stopper is a standard wine bottle cork, and wherein the opening in the generally planar surface has a depth greater than the diameter of the cork.

11. The display device of claim 9, and further comprising a movable cover member configured for placement over the generally planar surface and the opening in the generally planar surface, wherein the cover member is movable between an open position that allows the label to be placed onto the planar surface and the stopper to be placed into the opening, and a closed position in which the cover member holds the label in place on the planar surface and the stopper in place in the opening.

12. The display device of claim 11, wherein the cover member includes a transparent material through which the label is visible when the cover member is closed, and structure defining an open window through which the stopper is visible when the cover member is closed.

13. The display device of claim 11, wherein the cover member is hinged to structure at one side of the generally planar surface to rotate between its closed and open positions.

14. A display device comprising:
a folding structure having first and second sides hinged together to open and close in a book-like fashion;
a first display area on the first side of the folding structure, wherein the first display area is configured to hold and display at least one flat souvenir item; and
a second display area on the second side of the folding structure, wherein the second display area is configured to hold and display:
at least one additional flat souvenir item; and
at least one solid souvenir item;
wherein the flat souvenir items and the solid souvenir item are visible when the folding structure is open, and wherein the folding structure can be folded into its closed position when the souvenir items are present in the display areas.

15. The display device of claim 14, wherein the first display area includes a sleeve structure with an opening at one side of the sleeve, and a display card configured to receive and hold the flat souvenir item, wherein the display card is configured for insertion into the sleeve through the opening in the sleeve, and wherein the sleeve structure includes a transparent window material through which the flat souvenir item on the card can be viewed when the card is present in the sleeve.

16. The display device of claim 15, and further comprising a flexible transparent film, wherein the flexible transparent film can be peeled away from the card to place the flat souvenir item on the card, and then replaced on the card to hold the flat souvenir item in place.

17. The display device of claim 14, wherein the second display area includes a generally planar surface configured to receive and display the at least one additional flat souvenir item, and structure defining an opening in the generally planar surface, wherein the opening is configured to receive and display the solid souvenir item inside the opening.

18. The display device of claim 17, and further comprising a cover member movable between a closed and an open configuration, wherein the at least one additional flat souvenir item can be placed onto the generally planar surface and the solid souvenir item can be placed into the opening in the generally planar surface when the cover member is in the open position, and wherein the cover member retains and displays the at least one additional flat souvenir item and the solid souvenir item when the cover member is in the closed position.

19. The display device of claim 18, wherein the cover member is hinged to one side of the second display area for rotation between its open and closed positions.

20. The display device of claim 18, wherein the cover member includes a transparent window material through which the at least one additional flat souvenir item is visible when the flat souvenir item is in place on the generally planar surface and the cover is in the closed position, and structure defining an open window through which the solid souvenir item is visible when the solid souvenir item is in place in the opening in the generally planar surface and the cover is in the closed position.

21. The display device of claim 17, wherein the second display area is built into a box-like structure, wherein the generally planar surface is one surface of the box-like structure, wherein the opening in the generally planar structure is defined by structure of the box-like structure, and wherein the box-like structure is mounted onto the folding structure.

22. A business method for providing a customer of a commercial establishment with a keepsake in association with the provision to the customer by the establishment of a bottled beverage, the method comprising:
providing the customer with the bottled beverage;
removing a label from the beverage's bottle;
allowing the customer to take the removed label and the display device when the customer leaves the commercial establishment.

23. The business method of claim 22, wherein the bottled beverage is opened and at least partially consumed on the premises of the commercial establishment, and wherein the label is removed from the bottle by personnel of the commercial establishment.

24. The business method of claim 22, wherein removing the label from the beverage's bottle includes applying an adhesive film to the bottle and thereafter peeling the film away from the bottle.

25. The business method of claim 24, and further comprising supplying the commercial establishment with a supply of adhesive films for lifting labels from beverage bottles and display devices for adapted to display those labels.

26. The business method of claim 22, wherein the beverage is opened and at least partially consumed by the customer on the premises of the commercial establishment, and further comprising placing the label into the display device, wherein the label is placed in the display device by personnel of the establishment before the customer leaves the establishment.

27. The business method of claim 22, wherein the beverage is opened and at least partially consumed by the customer on the premises of the commercial establishment, and further comprising placing a beverage stopper from the beverage's bottle into the display device.

28. The business method of claim 27, wherein the beverage stopper is placed into the display device by personnel of the commercial establishment before the customer leaves the establishment.

29. The business method of claim 22, wherein the display device bears information signifying the identity of the commercial establishment.
